(19) United States
(12) Patent Application Publication
(10) Pub. No.: US 2023/0304677 A1
(43) Pub. Date: Sep. 28, 2023

(54) Method For Providing a Protective Climate Controlled Environment For A Work Crew

(71) Applicant: P3 Global Personnel, Houma, LA (US)

(72) Inventors: Gregory M. Cartolano, Houma, LA (US); Kelly J. Herbert, Bourg, LA (US)

(73) Assignee: P3 Global Personnel, Houma, LA (US)

(21) Appl. No.: 17/703,962

(22) Filed: Mar. 24, 2022

(51) Int. Cl. F24F 1/04; F16L 55/18

(52) U.S. Cl. CPC F24F 1/04; F16L 55/18; F24F 2221/12

(57) ABSTRACT

A method of providing a climate-controlled environment 360 degrees around an excavated targeted section of transmission pipeline used to transport natural gas and petroleum products and the like by providing a flexible air supportable enclosure, which targeted section of pipeline contains a defect that is capable of threatening the integrity of said pipeline and that needs to be repaired by a work crew.

### FIELD OF THE INVENTION

This invention relates to a method of providing a protective climate-controlled environment for a work crew to repair an anomaly associated with the wall of a transmission pipeline used for transporting petroleum and natural gas products.

### BACKGROUND OF THE INVENTION

The nation' s more than 2.6 million miles of pipelines safely deliver energy related commodities, such as trillions of cubic feet of natural gas, and hundreds of billions of ton/miles of liquid petroleum products each year. These pipelines are essential because of the enormous volumes of commodity energy products they move each day which is well beyond the capacity of other forms of transportation, such as by rail or by road. A transmission pipeline, also sometimes referred to as a mainline pipeline, is the principle pipeline in a given system. They are typically between about 16 and 48 inches in diameter. Pipelines are one of the safest and most effective ways of transporting petroleum and natural gas from the wellhead to processing plants. However, pipeline operators are under substantial financial and environmental pressures to avoid incidents that can cause a release of petroleum or natural gas products. Therefore, the integrity of such pipelines is of high priority, not only for pipeline companies and governmental bodies, but also for people and businesses that live and operate in the vicinity of such pipelines. Various standards are required by governmental agencies and, as such, all such pipelines transporting energy products are required to undergo integrity inspection on a continual basis.

Transmission pipelines can be subjected to a variety of anomalies, including but not limited to, external corrosion, internal corrosion, metal loss, exterior and interior stress corrosion cracking, external damage, manufacturing defects, and construction defects. Transmission pipelines, most of which are buried underground, are typically inspected by the use of an instrument referred to as a “smart pig” which is placed in the pipeline and carried along with the flowing product. A smart pig is an inspection device comprised of a collection of sophisticated, primarily electronic, instruments powered by on-board batteries. The instruments collect and transmit data relating to any detected anomalies, particularly those that have the potential of jeopardizing the integrity of the pipeline. Non-limiting examples of such sophisticated instruments include a gps device, various sensors, including an ultra-sonic transmitter, as well as magnetic devices. If any anomalies are sensed, the corresponding data is transmitted to an operator as well as to a suitable data collection and storage device, as to the type of anomaly and its location. The precise location of the anomaly is targeted via gps coordinates.

A work crew is then sent to the designated location to excavate a targeted section of pipeline containing the anomaly. Although any length section of pipeline can be targeted and excavated at any given time, it is typical practice in some areas of the country to excavate a 30 ft to 80 ft. long section of pipeline containing one or more identified anomalies. Once the targeted section of pipeline is excavated and exposed, the pipe surface is cleaned for inspection and repair. For example, after excavation, the targeted section of pipeline will typically contain a layer of scale, including old coating material, which needs to be removed before proper inspection and repair can be performed.

One substantial problem that an inspection/repair crew often faces is sweating or icing of the exposed targeted section of pipeline—depending on season and location of the pipeline. The primary cause of sweating results when the outside surface of the pipe is colder than the temperature of the surrounding atmosphere, particular in hot humid locations. Rain, or snow, can sometimes result in icing of the exposed pipeline section in colder locations. When these conditions occur, work, such as sandblasting and recoating of a repaired section of pipeline, cannot be performed. It is customary that the crew wait until the next day at which the relative humidity is low enough so that sweating does not occur, or is warm enough to melt any icing formation before proper inspection and repair can resume. Needless to say, this presents a significant added cost for the pipeline operator. It also prolongs the repair of an anomaly that can result in a pipeline failure.

Thus, there is a significant need in the art for systems that allow work crews to excavate, inspect, and repair targeted sections of pipeline—regardless of normal weather conditions.

### SUMMARY OF THE INVENTION

In accordance with the present invention there is provided a method of providing a climate-controlled environment 360 degrees around an excavated targeted section of transmission pipeline used to transport natural gas and petroleum products and the like, which targeted section of pipeline contains a defect that is capable of threatening the integrity of said pipeline and which has been identified as needing to be repaired by a work crew, which method comprising:
a) constructing a flexible, air supportable enclosure 360 degrees around said excavated section of transmission pipeline, which enclosure is at least 12 feet wide and contains at least one door for allowing members of a work crew to enter and to exit said enclosure, wherein the interior space within said enclosure is of sufficient size capable of allowing the required number of work crew members to perform work required to repair said defect, which flexible air supportable enclosure is constructed of a material that is waterproof and whose physical properties are strong enough to withstand the activities of said work crew throughout the duration of repair of a defect;
b) providing a climate control system capable of providing both cooled air and heated air to said enclosure, which climate control system having at least one blower in fluid communication with the interior of said enclosure;
c) maintaining a flow of air from said climate control system at a volume and pressure that is sufficient to provide support for said air supportable enclosure to its intended dimensions;
d) monitoring the dew point temperature and relative humidity of the atmosphere within said enclosure;
e) adjusting the temperature and relative humidity of said air supply from said climate control system to the interior of said enclosure so that the temperature and relative humidity of said air supply is at a temperature greater than said dew point temperature and at a relative humidity below 100%; and
f) adjusting the flow of climate-controlled air into said enclosure at a rate and volume that will continue to support said enclosure.

It is preferred that the flexible air supportable enclosure of the present invention be substantially oblong in shape having a first end and a second end wherein the first end is sealingly attached at one end of the targeted section of said excavated pipeline and the second end is sealingly attached at the opposite end of said targeted section of said excavated pipeline.

It also preferred that the enclosure of the present invention contain at least one window capable of allowing natural light to enter into said interior space and to observe work being done inside of said enclosure;

In a preferred embodiment of the present invention the enclosure is constructed of a material that is: a) cloth-like; b) substantially waterproof; c) flexible enough to allow the enclosure to take its intended shape by use of forced air from said climate control system; d) strong enough to withstand the activities of workers preforming the needed work to inspect and repair the targeted section of pipeline; and e) comprised of a plurality easily removable panels fastened together by use of a suitable fastening means.

In another preferred embodiment, the material of which the enclosure of the present invention is constructed is a woven polyester material, coated with nylon or a polyvinyl chloride material for waterproofing.

In another preferred embodiment of the present invention the fastening means is a hoop and loop system.

In yet another preferred embodiment of the present invention the fastening means is a zipper.

### DETAILED DESCRIPTION OF THE INVENTION

As previously mentioned, pipeline maintenance and repair companies have evaluation processes for maintaining transmission pipelines, including but not limited to the use of so-called smart pigs. A smart pig measures several different elements from inside the pipeline, inter alia, restrictions and deformations, metal loss, as well as other anomalies. It will be understood that the terms “anomaly” and “defect” are used interchangeably herein.

Once these anomalies are found and recorded, the exact location on the pipeline of the anomaly will be identified. As previously mentioned, use of the enclosure of the present invention alleviates a costly and time-consuming problem often encountered by work crews sent to inspect and repair targeted sections of pipeline. The problem being sweating or icing of the exterior surface of exposed pipeline, which prevents important work that is required to be done. Such important work includes things like sandblasting and recoating of the pipe surface after repair. While sweating, condensation, and icing are mentioned here when describing conditions on the pipe surface that will prevent certain work from being done, it is to be understood that any condition that will cause the pipe surface to be wet or icy needs to be avoided.

A typical excavation about a targeted section of pipeline will generally be from about 30 ft to about 80 ft long, about 12 ft wide, and about 8 ft deep, although location circumstance may require dimensions larger or smaller. The exact dimensions of the excavation is not critical to the instant invention as long as the designated one or more defects can be inspected and repaired. The larger size excavation will give a work crew adequate room to inspect and repair a defect located at any point around the entire exposed surface of the section of pipeline. Since the excavated pipe will typically contain a relatively heavy layer of scale, it is desired that this scale be removed. A portion of the scale will typically include tar-based coating material that was applied to the surface of the pipe for protection before being buried. This tar-based coating is generally removed by chipping it away by use of a hammering or chiseling tool. Sandblasting of any remaining scale is often required. Once the targeted section of pipeline is repaired, it is then recoated before being reburied. The coating used must have resistance to such things as root growth, soil bacteria, moisture, salts, acids and extreme temperatures. The most commonly used coatings to protect transmission pipelines include coal tar enamel, with or without an epoxy primer. Such a coating cannot be applied if the outside surface of the pipe is wet. It is to be understood that this invention is not limited to the coating material that is used to recoat the section of repaired pipeline. Any material suitable for such use can be used.

Use of the present elongated climate-controlled enclosure allows a work crew to inspect and repair a targeted section of transmission pipeline in substantially any normal weather condition. When the enclosure of the present invention is used, a work crew will not have to waste time and money waiting for a day when the relative humidity, or overall weather condition, is suitable for inspecting a performing the required work needed to repair any anomaly on a targeted section of pipeline.

The climate control system provided in accordance with the present invention can be any suitable air handling system, such as the well-known HVAC systems. For purposes of the present invention, such a system can be referred to as a DHVAC system because the goal of such a system is to provide relatively low humidity (dehumidified), temperature controlled air that helps prevent sweating of the pipe surface of the targeted section of pipeline. Controlling the temperature of the air conducted to the interior of said enclosure, by either heating or cooling, also provides a more favorable work environment for the workers, as well as aiding in preventing the pipe surface from sweating. At least one window panel is provided throughout the enclosure for both lighting purposes as well as for safety to enable observation into the enclosure, particularly during the repair and recoating process.

The enclosure of the present invention will also be provided with one or more vents for exhausting air from the enclosure. In a preferred embodiment, a support cable system comprised of a cable of suitable material, such as wire rope, can be provided above the enclosure as a safety precaution should the climate control system fail to provide the enough air flow and volume to continue to support the enclosure. The cable support system can be secured to anchors outside and above the enclosure, but which will attach at various locations along the enclosure, such as bring passed through a plurality of fabric loops of said enclosure. This aids in both the early construction stage of the enclosure as well as providing another means (other than forced air) of holding the enclosure in place at the predetermined height. The support cable system can be anchored in place by any suitable anchors at both ends of said enclosure.

The flow of controlled air entering the enclosure from said climate control system, and exhausted from the enclosure via previously mentioned vents, can easily be calculated and controlled by those having at least ordinary skill the art as to flow rate, flow volume, temperature, and relative humidity. Thus, the number and size of input ports and exhaust vents will depend on such things as the final size of the enclosure, atmospheric conditions outside of the enclosure, and the number of workers located inside the enclosure.

The manner in which an enclosure of the present invention is constructed is not critical as long as: it is capable of being supported by a flow of forced air from said climate control system; it be substantially weather proof; it contain at least one, preferably a plurality of window panels on both the top as well as the sides; that it contain at least one door, one of which is at an end of the enclosure and at least one at the sides;

and that be large enough to house the entire targeted section of pipeline and accommodate a work crew with their required tools for inspecting and repairing the targeted section of pipeline.

In a preferred embodiment, the overall enclosure is constructed of several main sections, such as a roof section, a floor section, 2 side sections, and 2 end sections. Each section is comprised of a plurality of panels of a suitable industrial strength flexible material. The term “industrial strength” as used herein means it's most commonly used meaning that it be so strong and durable as to be suitable for industry. Flexible industrial strength materials suitable for use herein include those that are: a) cloth-like, b) substantially waterproof, c) flexible enough to allow it to take the desire elongated form by use of forced air; d) strong enough to withstand the activities of a work crew performing required types of work and equipment needed to inspect, repair, and coat an exposed targeted section of pipeline; and e) that it be of a material that can be easily removably joined together by use of suitable joining means. A preferred material of which the enclosures of the present invention are comprised are woven polyester material, coated with nylon or a polyvinyl chloride material for waterproofing. Preferred is a woven polyester material coated with polyvinyl chloride.

Non-limiting examples of joining means that can be used in the practice of the present invention for removably joining panels together, or for joining sections of the enclosure together include: hook and loop fasteners, such as those available under the tradename “Velcro”, industrial strength zippers, magnetic fasteners, metal or plastic snaps, zippers, and the like. Preferred fasteners are the hook and loop fasteners and zippers, particularly industrial strength hook and loop fasteners and zippers. More preferred, especially when joining sections together, as well as for doors, is when a hook and loop system is used in combination with a zipper section, as illustrated in FIGS. 6a and 6b hereof. That is, when both a zipper system and the hook and loop system are aligned substantially parallel at the vicinity of the edge of the panel, or section. For example, the hood and loop system will be closest to the outer edge (½ to 2 inches) and the zipper system will be about 1 to 2 inches from the hook and loop system. It is preferred that only the hook and loop fastening system be used only when fastening the panels together.

Although the panels used to fabricate the sections of the enclosure of the present invention can be any shape, it is preferred that they be rectangular, primarily for ease of construction.

What is claimed is:

1. A method of providing a climate-controlled environment 360 degrees around an excavated targeted section of transmission pipeline used to transport natural gas and petroleum products and the like, which targeted section of pipeline contains a defect that is capable of threatening the integrity of said pipeline and which has been identified as needing to be repaired by a work crew, which method comprising:
a) constructing a flexible, air supportable primary enclosure 360 degrees around said excavated section of transmission pipeline, which enclosure is at least 12 feet wide and contains at least one door for allowing members of a work crew to enter and to exit said enclosure, wherein the interior space within said enclosure is of sufficient size capable of allowing the required number of work crew members to perform work required to repair said defect, which flexible air supportable enclosure is constructed of a material that is waterproof and whose physical properties are strong enough to withstand the activities of said work crew throughout the duration of repair of said defect;
b) providing a climate control system capable of providing both cooled air and heated air to said enclosure, which climate control system having at least one blower in fluid communication with the interior of said enclosure;
c) maintaining a flow of air from said climate control system at a volume and pressure that is sufficient to provide support for said air supportable enclosure to its intended dimensions;
d) continuously monitoring the dew point temperature and relative humidity of the atmosphere within said enclosure;
e) continuously adjusting the temperature and relative humidity of said air supply from said climate control system to the interior of said enclosure so that the temperature and relative humidity of said air supply is at a temperature greater than said dew point temperature and at a relative humidity below 100%; and
f) adjusting the flow of climate-controlled air into said enclosure at a rate and volume that will continue to support said enclosure.

2. The method of claim 1 wherein an inner secondary enclosure is constructed within said primary enclosure wherein said secondary enclosure is also constructed 360 degrees around said excavated targeted section of pipeline, which secondary enclosure also has an inner space similar to that of the primary enclosure by primary functioning as a means for collecting waste resulting from repair of said targeted pipeline.

3. The method of claim 1 wherein the primary enclosure is comprised of plurality of rectangular panels secured together by any suitable means.

4. The method of claim 3 wherein said suitable means for securing said plurality of rectangular panels are hook and loop fasteners.

5. The method of claim 3 wherein said suitable means for securing said plurality of rectangular panels are zippers.

6. The method of claim 1 wherein the material of which said enclosure is comprised is a woven polyester material coated with nylon.

7. The method of claim 1 wherein the material of which said enclosure is comprised is a woven polyester material coated with polyvinyl chloride.

8. The method of claim 1 wherein the climate control system is a DHVAC system of an effective size to provide the volume and air pressure appropriate for supporting said enclosure and for providing the desired temperature and relative humidity
